(19) United States
(12) Patent Application Publication
(10) Pub. No.: US 2011/0220786 A1
(43) Pub. Date: Sep. 15, 2011

(54) Tandem Time-of-Flight Mass Spectrometer

(75) Inventor: Takaya Satoh, Tokyo (JP)

(73) Assignee: JEOL LTD., Tokyo (JP)

(21) Appl. No.: 13/026,496

(22) Filed: Feb. 14, 2011

(30) Foreign Application Priority Data
Mar. 11, 2010 (JP) 2010-054278
Dec. 17, 2010 (JP) 2010-281402

(51) Int. Cl. H01J 49/40

(52) U.S. Cl. 250/287

(57) ABSTRACT

A tandem time-of-flight (TOF) mass spectrometer is offered whose first mass analyzer is a TOF mass spectrometer having a flight distance smaller than the flight distance sufficient to impart a desired mass resolution to the first mass analyzer. When a mass spectrum is measured with the first mass analyzer, a reflectron field is activated. When precursor ions are selected by the first mass analyzer, the reflectron field is deactivated to permit ions to pass through without being reflected.

### BACKGROUND OF THE INVENTION

1. Field of the Invention

The present invention relates to a tandem time-of-flight (TOF) mass spectrometer used for qualitative analysis and quantitative analysis of trace compounds.

2. Description of Related Art

[Mass Spectrometer]

A mass spectrometer ionizes a sample in an ion source, separates the ions in a mass analyzer according to their mass-to-charge ratio (m/z), and detects the separated ions by a detector. The result is displayed in the form of a mass spectrum where m/z values are plotted on the horizontal axis, while the relative intensity is plotted on the vertical axis. Consequently, m/z values and relative intensities of compounds contained in the sample are obtained. Qualitative and quantitative information about the sample can be derived. Ionization, mass separation, and ion detection can be implemented by various methods. Among others, the present invention is most deeply associated with mass separation. Mass spectrometers are classified into quadrupole mass spectrometer (QMS), ion trap mass spectrometer (ITMS), magnetic-sector type mass spectrometer, time-of-flight mass spectrometer (TOF-MS), Fourier transform ion cyclotron mass spectrometer (FTICRMS), and so on, according to the principle of mass separation.

[MS/MS Measurements and MS/MS Instruments]

In a mass spectrometer, ions created in an ion source are separated in a mass analyzer according to m/z values and detected. The results are represented by a mass spectrum in which m/z values and relative intensities of the ions are graphed. This kind of measurement is hereinafter referred to as an MS measurement in contrast with MS/MS measurement described later. In an MS/MS measurement, certain ions created in the ion source are selected (precursor ions) by the first stage of mass spectrometer (hereinafter abbreviated MS1) and spontaneously fragmented or induced to fragment, and the produced ions (product ions) are mass analyzed in a later stage of mass spectrometer (hereinafter abbreviated MS2). An instrument capable of implementing this measurement is referred to as an MS/MS instrument (FIG. 1).

In an MS/MS measurement, structural information about precursor ions can be obtained because the m/z values of the precursor ions, the m/z values of product ions produced in fragmentation paths, and information about relative intensities are derived (FIG. 2). Various variations exist to MS/MS instruments capable of performing MS/MS measurements, and each variation is made of any two of the aforementioned mass spectrometers. Furthermore, fragmentation methods include collision-induced dissociation (CID) utilizing collision with gas, photodissociation, and electron capture dissociation. Associated with the present invention is an MS/MS instrument having two TOF mass spectrometers connected in tandem with an intervening fragmentation means employing a CID method. Generally, this is known as a TOF/TOF instrument.

Dissociation information derived from an MS/MS instrument utilizing a CID method differs according to the collision energy, i.e., according to the magnitude of kinetic energy of ions entering the collision cell. In the case of presently available MS/MS instruments, kinetic energies are classified into two kinds, i.e., low collision energies on the order of tens of eV (low-energy CID) and high collision energies of several to tens of keV (high-energy CID), depending on the instrumental configuration. This is summarized in Table 1.

TABLE 1

| MS1 | MS2 | collision energy |
|---|---|---|
| QMS | QMS | low |
| QMS | TOF-MS | low |
| TOF-MS | TOF-MS | high |
| magnetic sector MS | magnetic sector MS | high |
| magnetic sector MS | QMS | low |
| ion-trap MS | ion-trap MS | low |
| ion-trap MS | TOF-MS | low |
| FTICR-MS | FTICR-MS | low |

High-energy CID has the advantage that when a peptide having tens of amino acids chained together is fragmented, side chain information may be obtained. It is possible to distinguish peptides from leucine and isoleucine having the same molecular weight.

[Time-of-Flight Mass Spectrometer (TOF-MS)]

TOF-MS is a mass spectrometer in which ions are accelerated by imparting a given amount of energy to them to make them fly. The mass-to-charge ratios of the ions are found from the times taken for them to reach the detector. In the TOF-MS, the ions are accelerated by a given pulsed voltage Vₐ. At this time, from the law of energy conservation, the velocity v of each ion is given by

mv²/2=qeVₐ (1)

v=\sqrt{2qeV/m} (2)

where m is the mass of the ion, q is the charge of the ion, and e is the elementary charge.

The ions arrive at a detector placed at a given distance of L behind in a flight time T.

$$T = \frac{L}{v} = L \sqrt{\frac{m}{2 qe V}} \qquad ( 3 )$$

Eq. (3) indicates that the flight time T varies according to the mass m of the ion. The time-of-flight mass spectrometer (TOF-MS) separates masses utilizing this fact. One example of linear TOF mass spectrometer is shown in FIG. 3. Furthermore, reflectron TOF mass spectrometers permitting improvement in energy convergence and elongation of the flight distance by placing a reflectron field between the ion source and the detector are widely used. One example of reflectron TOF mass spectrometer is shown in FIG. 4.

[Spiral-Trajectory TOF-MS]

The mass resolution of a TOF-MS is defined as:

mass resolution=T/2ΔT (4)

where T is the total flight time and ΔT is the peak width. That is, the mass resolution can be improved if the total flight time T can be increased while keeping the peak width ΔT constant. However, in the related art linear and reflectron TOF-MS instruments, increasing the total flight time T (i.e., the total flight distance) directly leads to an increase in the size of the apparatus. A multi-turn TOF-MS is an apparatus which has been developed to avoid increase in instrumental size and to achieve high mass resolution Toyoda, Okumura, Ishihara and Katakuse, J. Mass Spectrom., 2003, 38, pp. 1125-1142. This apparatus uses four toroidal electric fields, each consisting of a combination of a cylindrical electrode and Matsuda plates. The total flight time T can be elongated by causing the ions to make multiple turns in a trajectory resembling the figure of 8. In this apparatus, the spatial and temporal spread at the detection surface have been successfully converged up to the first-order terms by appropriately setting the initial position, initial angle, and initial kinetic energy.

However, the TOF-MS in which ions revolve many times around a closed trajectory suffers from the problem of overtaking. That is, because ions revolve multiple times round a closed trajectory, smaller m/z ions moving at higher speeds overtake larger m/z ions moving at smaller speeds. Consequently, the fundamental concept of TOF-MS that ions arrive at the detection surface in turn from the lightest one does not hold.

The spiral-trajectory TOF-MS has been devised to solve this problem (see JP-A-2007-227042). The spiral-trajectory TOF-MS is characterized in that the starting and ending points of a closed trajectory are shifted from the closed trajectory plane in the vertical direction. To achieve this, in one method, ions are made to inject obliquely from the beginning (see JP-A-2000-243345). In another method, the starting and ending points of the closed trajectory are shifted in the vertical direction using a deflector (see JP-A-2003-86129). In a further method, laminated toroidal electric fields are used (see JP-A-2006-12782).

Another TOF-MS has been devised which is based on a similar concept but in which the trajectory of the multi-turn TOF-MS (see GB 2 080 021) where overtaking occurs is zigzagged (see WO 2005/001878).

[Tandem TOF-MS]

An MS/MS instrument in which two TOF mass spectrometers are connected in tandem is generally known as a tandem TOF mass spectrometer (or TOF/TOF instrument). MS/MS instruments are mainly used in equipment adopting a MALDI ion source. Many of related art tandem TOF instruments are made of a linear TOF-MS and a reflectron TOF-MS (FIG. 5). An ion gate for selecting precursor ions is mounted between the two TOF-MSs. The focal point of the first TOF-MS is placed near the ion gate.

There are recent reports that the first TOF-MS is not a linear TOF-MS but a multi-turn TOF-MS or spiral-trajectory TOF-MS. The second TOF-MS is largely made of a reflectron TOF-MS because it is necessary to analyze fragment ions having a wide distribution of kinetic energies.

In the case of a tandem TOF-MS including a spiral-trajectory TOF-MS and a reflectron TOF-MS as its first and second mass spectrometers, respectively, the flight distance necessary to secure the performance (such as a mass resolution of 50,000) of the first MS (TOF-MS) is generally greater than the flight distance for securing a sufficient precursor ion selectivity (such as the ability to distinguish ions with m/z of 3,000 from ions with m/z of 3,001).

Therefore, in order to secure the performance of the first MS, the first MS is required to have a flight distance that is undesirably great for the precursor ion selectivity. The great flight distance contributes to improvements in mass resolution and mass accuracy of the TOF-MS but the ion transmittance may deteriorate, especially when the ions induce spontaneous dissociation. This may be disadvantageous to the tandem TOF-MS in which ion intensities tend to decrease due to fragmentations into plural pathways.

### SUMMARY OF THE INVENTION

In view of the foregoing, it is an object of the present invention to provide a tandem TOF-MS whose first MS is a TOF-MS having a flight distance which would normally be too short to impart a desired mass resolution to the first MS but can impart the desired mass resolution to the first MS.

This object is achieved by a tandem TOF (time-of-flight) mass spectrometer associated with the present invention, the spectrometer including: an ion source for ionizing a sample to produce ions, a first TOF mass analyzer including plural electric sectors and accepting the ions accelerated by an accelerating voltage, a first detector for detecting ions dispersed according to their mass-to-charge ratio by the first TOF mass analyzer, an ion gate for extracting only ions having a desired mass-to-charge ratio from the ions dispersed according to their mass-to-charge ratio by the first TOF mass analyzer, ion fragmentation means into which precursor ions passed through the ion gate are introduced to fragment the ions, a second TOF mass analyzer placed behind the ion fragmentation means and analyzing the masses of the fragmented ions, and a second detector for detecting ions passed through the second TOF mass analyzer. The tandem TOF mass spectrometer further includes a reflectron field placed at the exit of the first TOF mass analyzer, ion extraction means, and control means. The reflectron field can be activated and deactivated, and reflects ions traveling forwardly in a trajectory within the first TOF mass analyzer to cause the ions to travel rearwardly in the trajectory. The ion extraction means causes the ions traveling rearwardly in the first TOF mass analyzer after being reflected by the reflectron field to be directed at the first detector so as to detect on it. The control means controls the ion extraction means in such a way that, when a mass spectrum is measured using the first TOF mass analyzer and the first detector, the reflectron field is activated and that ions traveling forwardly in the first TOF mass analyzer are left unhindered, while ions traveling rearwardly in the first TOF mass analyzer after being reflected by the reflectron field are directed at the first detector so as to detect on it.

In one feature of the invention, the reflectron field is formed using plural electrodes including an entrance electrode and an exit electrode. When the reflectron field is activated, a reflectron electron field is produced to cause ions entering from the entrance electrode to travel rearwardly and exit from the entrance electrode in the reverse direction. When the reflectron field is deactivated, all the electrodes are made substantially equipotential. Consequently, the ions entering from the entrance electrode intact exit from the exit electrode without being affected by the electrodes.

In another feature of the invention, the reflectron field is produced by applying a reverse potential difference greater than accelerating voltage for the ions between the entrance electrode and the exit electrode.

In a further feature of the invention, each of the entrance and exit electrodes is a mesh-like electrode or a conductive plate having an ion passage hole.

In a yet other feature of the invention, at least one of the entrance and exit electrodes is the conductive plate having the ion passage hole. There is further provided scattering-suppressing means for suppressing scattering of ions due to disturbance of the electric field within the reflectron field caused by the ion passage hole.

In an additional feature of the invention, the scattering-suppressing means are lens electrodes mounted ahead of and behind the ion passage hole.

In a still other feature of the invention, an ion trajectory-adjusting mechanism is mounted ahead of or behind the reflectron field.

In a yet additional feature of the invention, the ion trajectory-adjusting mechanism is configured including a deflector or lens electrodes.

In a further additional feature of the invention, the ion fragmentation means is a collision cell for dissociating ions by collision-induced dissociation.

The invention also provides a tandem TOF mass spectrometer including: an ion source for ionizing a sample to produce ions; a first TOF mass analyzer including plural electric sectors and accepting the ions accelerated by an accelerating voltage; a first detector for detecting ions dispersed according to their mass-to-charge ratio by the first TOF mass analyzer; an ion gate for extracting only ions having a desired mass-to-charge ratio from the ions dispersed according to their mass-to-charge ratio by the first TOF mass analyzer; ion fragmentation means into which precursor ions passed through the ion gate are introduced to fragment the ions; a second TOF mass analyzer placed behind the ion fragmentation means and analyzing the masses of the fragmented ions; a second detector for detecting ions passed through the second TOF mass analyzer; and a reflectron field disposed at the exit of the first TOF mass analyzer. The reflectron field can be activated and deactivated, and reflects ions traveling forwardly in a trajectory within the first TOF mass analyzer to cause the ions to travel rearwardly in the trajectory. The tandem TOF mass spectrometer has a first analysis mode and a second analysis mode. In the first mode, the reflectron field is activated to reflect the ions to cause them to travel rearwardly in the first TOF mass analyzer. In the second mode, the reflectron field is deactivated to permit the ions to pass toward the ion fragmentation means without being reflected by the reflectron field.

One tandem TOF mass spectrometer of the invention includes: an ion source for ionizing a sample to produce ions; a first TOF mass analyzer including plural electric sectors and accepting the ions accelerated by an accelerating voltage; a first detector for detecting ions dispersed according to their mass-to-charge ratio by the first TOF mass analyzer; an ion gate for extracting only ions having a desired mass-to-charge ratio from the ions dispersed according to their mass-to-charge ratio by the first TOF mass analyzer; ion fragmentation means into which precursor ions passed through the ion gate are introduced to fragment the ions; a second TOF mass analyzer placed behind the ion fragmentation means and analyzing the masses of the fragmented ions; and a second detector for detecting ions passed through the second TOF mass analyzer. The tandem TOF mass spectrometer further includes a reflectron field placed at the exit of the first TOF mass analyzer, ion extraction means, and control means. The reflectron field can be activated and deactivated, and reflects ions traveling forwardly in a trajectory within the first TOF mass analyzer to cause the ions to travel rearwardly in the trajectory. The ion extraction means causes the ions traveling rearwardly in the first TOF mass analyzer after being reflected by the reflectron field to be directed at the first detector so as to detect on it. The control means controls the ion extraction means in such a way that, when a mass spectrum is measured using the first TOF mass analyzer and the first detector, the reflectron field is activated and that ions traveling forwardly in the first TOF mass analyzer are left unhindered, while ions traveling rearwardly in the first TOF mass analyzer after being reflected by the reflectron field are directed at the first detector so as to detect on it. Consequently, the tandem TOF mass spectrometer can be offered which can provide a desired mass resolution using a TOF mass analyzer having a flight distance shorter than the flight distance that would normally give the desired mass resolution to the first mass analyzer.

Other objects and features of the invention will appear in the course of the description thereof, which follows.

### BRIEF DESCRIPTION OF THE DRAWINGS

FIG. 1 is a block diagram of a related art MS/MS instrument;

FIG. 2 is a diagram illustrating a related art MS/MS measurement;

FIG. 3 illustrates a related art linear TOF mass spectrometer;

FIG. 4 illustrates a related art reflectron TOF mass spectrometer;

FIG. 5 is a block diagram of a related art tandem TOF mass spectrometer;

FIGS. 6A and 6B are schematic representations of a tandem TOF mass spectrometer associated with the present invention; and

FIGS. 7A, 7B, 7C and 7D illustrate a simple embodiment of a first reflectron field.

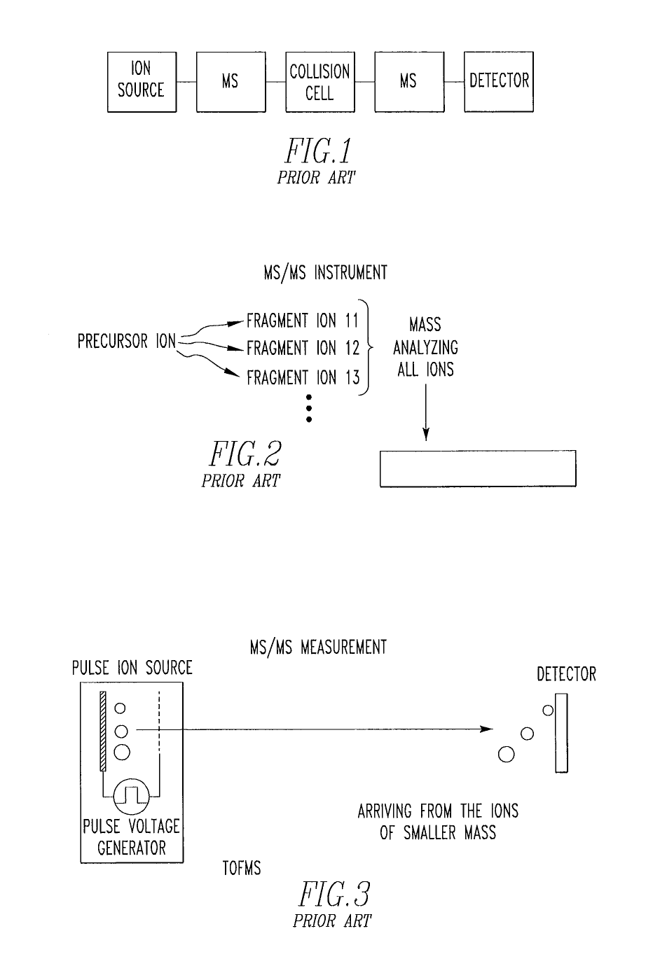

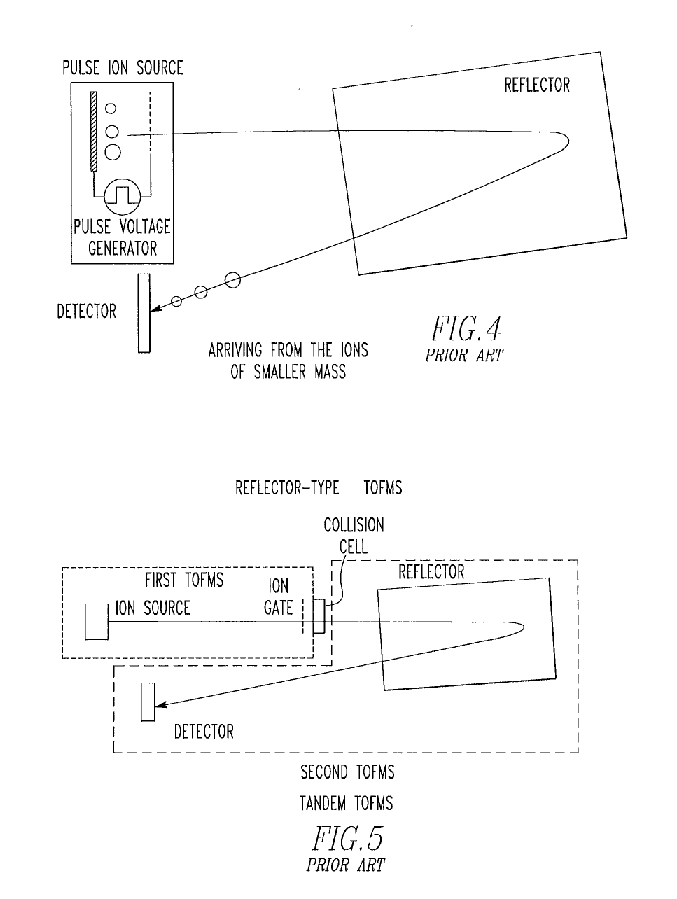

### DESCRIPTION OF THE PREFERRED EMBODIMENTS

The preferred embodiments of the present invention are hereinafter described with reference to the drawings. In the description of the preferred embodiments, a spiral-trajectory TOF mass spectrometer including four electric sectors is used as the first TOF mass analyzer as one example. Similarly, a multi-turn type having a jig-saw trajectory can be used as the first TOF mass analyzer.

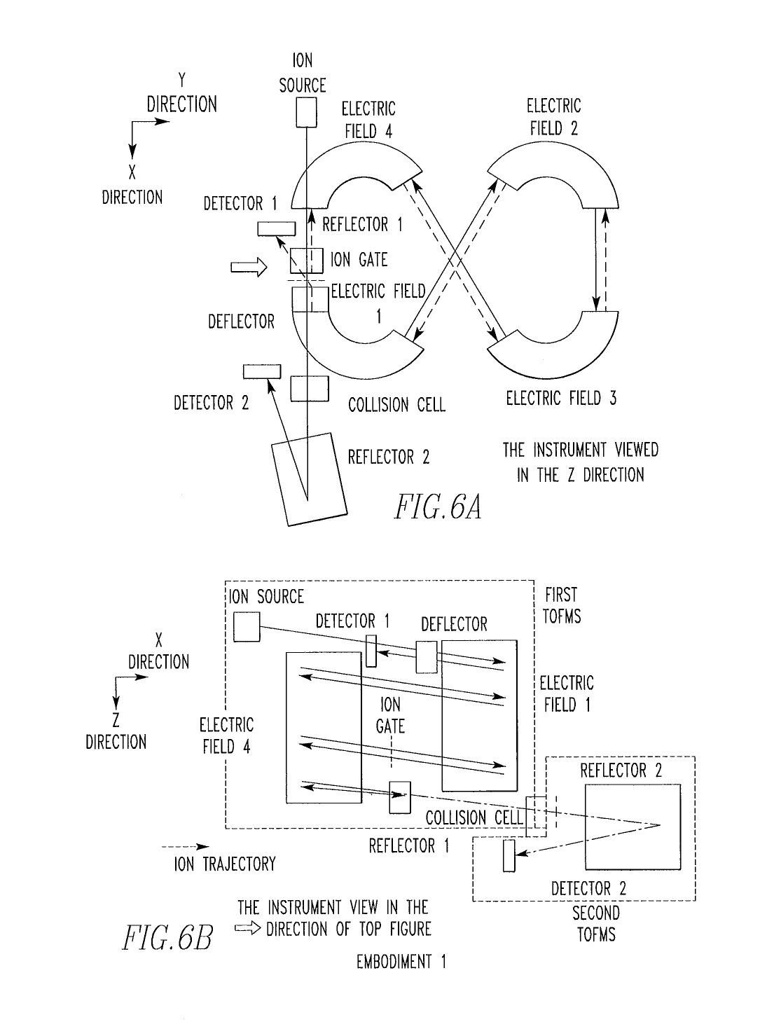

FIG. 6A illustrates one embodiment of the invention. FIG. 6A is a diagram of the instrument as viewed along the Z-direction. FIG. 6B is a diagram taken in the Y-direction of FIG. 6A (indicated by the wide arrow). The illustrated instrument includes an ion source 1, electric sectors 2-5 stacked in multiple layers in the Z-direction to form an 8-shaped spiral trajectory, an ion gate 6 for selecting precursor ions, a first reflectron field 7 for reflecting ions, a deflector 8 for deflecting ions from the spiral trajectory into a first detector 9 that detects the ions deflected from the spiral trajectory, a collision cell 10 for fragmenting ions by collision-induced dissociation, a second reflectron field 11 for mass separating the fragmented ions, and a second detector 12 for detecting the ions that have been mass separated by the reflectron field 11. An ion-decelerating region may be disposed in a stage preceding the collision cell 10. In the example of FIG. 6B, the ion gate is placed within the spiral trajectory. Alternatively, the gate may be placed behind the spiral trajectory.

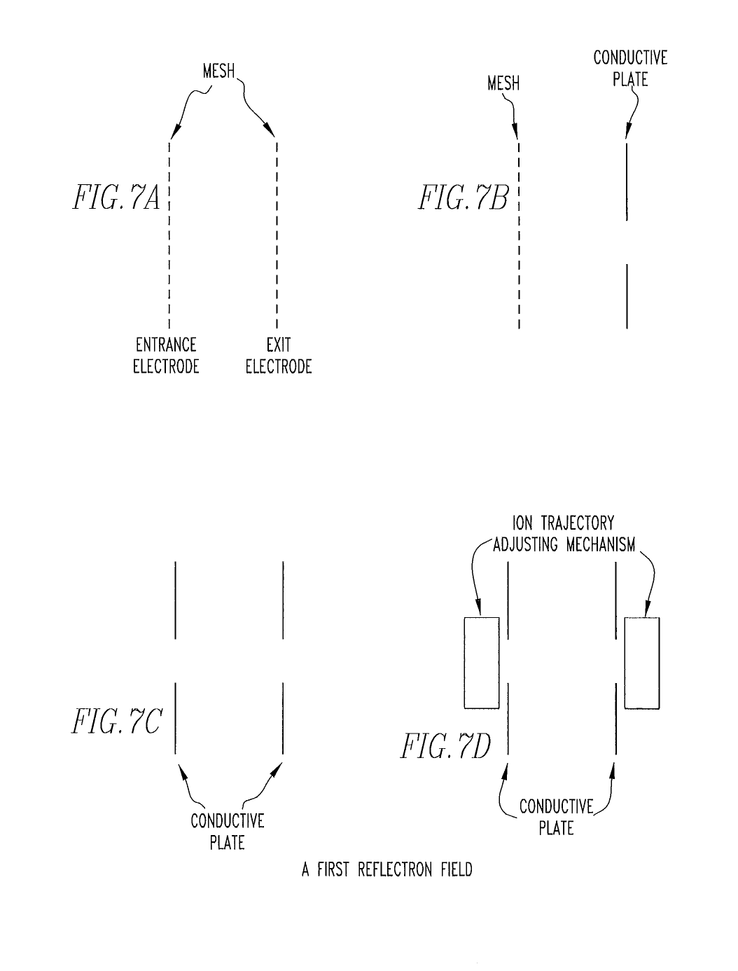

The first reflectron field that is an important feature of the present embodiment is first described. The first reflectron field 7 is formed using two or more electrodes. FIGS. 7A, 7B, 7C and 7D show simple examples consisting of an entrance electrode and an exit electrode. When this reflectron field is activated, ions are reflected, while when the field is deactivated, ions are allowed to pass through.

That is, when ions are reflected by the reflectron field 7 (when the field is activated), a reverse potential difference greater than the accelerating voltage for the ion is applied between the entrance and exit electrodes. On the other hand, when the ions are allowed to pass through (when the field is deactivated), the entrance and exit electrodes are made equipotential. Each of the entrance and exit electrodes may be made of a mesh-like electrode or a conductive plate having an ion passage hole.

In the latter case, however, it is necessary to suppress scattering of ions due to disturbance of the electric field within the reflectron field caused by the ion passage hole. For this reason, lens electrodes may be mounted ahead of and behind the ion passage hole. Furthermore, an ion trajectory-adjusting mechanism such as a deflector or lens electrodes may be located ahead of the entrance electrode and/or behind the exit electrode.

The operation of the present embodiment is described below. First, sample compounds are ionized in the ion source and accelerated and directed into the spiral-trajectory TOF-MS (the first TOF mass analyzer).

Where a mass spectrum is measured by the first TOF mass analyzer, the first reflectron field 7 is activated. Thus, the ions are allowed to pass through the successive layers of the electric sectors 2-5 (path indicated by the solid lines in FIGS. 6A and 6B) are reflected by the first reflectron field 7 and travel in the reverse direction (path indicated by the broken lines in FIGS. 6A and 6B).

When the ions make a first pass, the deflector 8 is deactivated. The deflector 8 is activated before the ions come back after traveling rearwardly through the spiral trajectory. Consequently, the ions are deflected out of the spiral trajectory and detect on the first detector 9. As a result, the ions can be observed as a mass spectrum. After the deflector has been activated, the ions cannot travel toward the electric sectors and so only the ions passed through the deflector 8 during a period beginning with the deactivation of the deflector and ending with the activation are measured.

Where precursor ions are selected by the first TOF mass analyzer and fragment ions are measured by the second TOF mass analyzer, the first reflectron field 7 is deactivated. Consequently, with respect to ions passed sequentially through the layers of the electric sectors 2-5 (paths indicated by the solid line in FIGS. 6A and 6B), precursor ions are selected at the ion gate 6 (path indicated by the dot-and-dash lines in FIG. 6B).

The selected precursor ions pass through the first reflectron field 7 without being reflected and create fragment ions in the collision cell 10. Then, the masses are separated in the second TOF mass analyzer including the second reflectron field 11. The ions are observed as a mass spectrum at the second detector 12 (path indicated by the dot-and-dash line in FIG. 6B).

The present invention can find wide application in measurements using a tandem TOF mass spectrometer.

Having thus described my invention with the detail and particularity required by the Patent Laws, what is desired protected by Letters Patent is set forth in the following claims.

The invention claimed is:

1. A tandem time-of-flight (TOF) mass spectrometer having an ion source for ionizing a sample to produce ions, a first TOF mass analyzer including plural electric sectors and accepting the ions accelerated by an accelerating voltage, a first detector for detecting ions dispersed according to their mass-to-charge ratio by the first TOF mass analyzer, an ion gate for extracting only ions having a desired mass-to-charge ratio from the ions dispersed according to their mass-to-charge ratio by the first TOF mass analyzer, ion fragmentation means into which precursor ions passed through the ion gate are introduced to fragment the ions, a second TOF mass analyzer placed behind the ion fragmentation means and analyzing the masses of the fragmented ions, and a second detector for detecting ions passed through the second TOF mass analyzer, said tandem TOF mass spectrometer comprising:
a reflectron field placed at an exit of the first TOF mass analyzer and reflecting ions traveling forwardly in a trajectory within the first TOF mass analyzer to cause the ions to travel rearwardly in the trajectory, the reflectron field being capable of being activated and deactivated;
ion extraction means for causing the ions traveling rearwardly in the first TOF mass analyzer after being reflected by the reflectron field to be directed at the first detector so as to detect thereupon; and
control means for controlling the ion extraction means in such a way that, when a mass spectrum is measured using the first TOF mass analyzer and the first detector, the reflectron field is activated and that ions traveling forwardly in the first TOF mass analyzer are left unhindered, while ions traveling rearwardly in the first TOF mass analyzer after being reflected by the reflectron field are directed at the first detector so as to detect thereupon.

2. A tandem time-of-flight (TOF) mass spectrometer as set forth in claim 1,
wherein said reflectron field is formed using plural electrodes including an entrance electrode and an exit electrode,
wherein, when the reflectron field is activated, a reflectron electric field is produced to cause ions entering from the entrance electrode to travel rearwardly and exit from the entrance electrode in a reverse direction, and
wherein, when the reflectron field is deactivated, all the electrodes are made substantially equipotential, whereby the ions entering from the entrance electrode intact exit from the exit electrode without being affected by the electrodes.

3. A tandem time-of-flight (TOF) mass spectrometer as set forth in claim 2, wherein said reflectron field is produced by applying a reverse potential difference greater than the accelerating voltage for the ions between said entrance electrode and said exit electrode.

4. A tandem time-of-flight (TOF) mass spectrometer as set forth in any one of claims 2 and 3, wherein each of said entrance electrode and said exit electrode is a mesh-like electrode or a conductive plate having an ion passage hole.

5. A tandem time-of-flight (TOF) mass spectrometer as set forth in claim 4, wherein at least one of said entrance electrode and said exit electrode is the conductive plate having the ion passage hole, and wherein there is further provided scattering-suppressing means for suppressing scattering of ions due to disturbance of an electric field within the reflectron field caused by the ion passage hole.

6. A tandem time-of-flight (TOF) mass spectrometer as set forth in claim 5, wherein said scattering-suppressing means are lens electrodes mounted respectively ahead of and behind the ion passage hole.

7. A tandem time-of-flight (TOF) mass spectrometer as set forth in claim 2, wherein an ion trajectory-adjusting mechanism is mounted ahead of or behind said reflector field.

8. A tandem time-of-flight (TOF) mass spectrometer as set forth in claim 7, wherein said ion trajectory-adjusting mechanism is configured including a deflector or lens electrodes.

9. A tandem time-of-flight (TOF) mass spectrometer as set forth in claim 1, wherein said ion fragmentation means is a collision cell for dissociating ions by collision-induced dissociation.

10. A tandem time-of-flight (TOF) mass spectrometer having an ion source for ionizing a sample to produce ions, a first TOF mass analyzer including plural electric sectors and accepting the ions accelerated by an accelerating voltage, a first detector for detecting ions dispersed according to their mass-to-charge ratio by the first TOF mass analyzer, an ion gate for extracting only ions having a desired mass-to-charge ratio from the ions dispersed according to their mass-to-charge ratio by the first TOF mass analyzer, ion fragmentation means into which precursor ions passed through the ion gate are introduced to fragment the ions, a second TOF mass analyzer placed behind the ion fragmentation means and analyzing the masses of the fragmented ions, a second detector for detecting ions passed through the second TOF mass analyzer, and a reflectron field disposed at an exit of the first TOF mass analyzer, the reflectron field being capable of being activated and deactivated, the reflectron field acting to reflect ions traveling forwardly in a trajectory within the first TOF mass analyzer to cause the ions to travel rearwardly in the trajectory;
said tandem TOF mass spectrometer having a first analysis mode in which the reflectron field is activated to reflect the ions to cause them to travel rearwardly in the first TOF mass analyzer and a second analysis mode in which the reflectron field is deactivated to pass the ions toward the ion fragmentation means without being reflected by the reflectron field.
